(19) United States
(12) Patent Application Publication
(10) Pub. No.: US 2002/0078153 A1
(43) Pub. Date: Jun. 20, 2002

(54) Providing secure, instantaneous, directory-integrated, multiparty, communications services

(76) Inventors: Chit Chung, Marlboro, NJ (US); Siddhartha Dalal, Bridgewater, NJ (US); Giovanni Di Crescenzo, Chatham, NJ (US); Richard Graveman, Morristown, NJ (US); Michael Long, Edison, NJ (US); Gardner Patton, Bridgewater, NJ (US); Hyong Sop Shim, Basking Ridge, NJ (US)

Correspondence Address: Telcordia Technologies, Inc., 445 South Street, Morristown, NJ, 07960, US

(21) Appl. No.: 10/002,882

(22) Filed: Nov. 2, 2001

Related U.S. Application Data
(60) Provisional application No. 60/245,136, filed on Nov. 2, 2000.

(51) Int. Cl. G06F 15/16; H04L 12/16; H04Q 11/00

(52) U.S. Cl. 709/204; 370/260

(57) ABSTRACT

A method and system for providing secure, instantaneous, multiparty, real-time, communications. Users can engage in text or audio conferences on demand with security. The system and method is characterized by a client server architecture with a centralized process for controlling communications access; and a plurality of client applications each located with an end user for control, and with each end user having a device for effecting the communications which may be combined with or operated separately from the client application controlling the communications session.

### RELATED APPLICATIONS

This application is related and claims priority to United States Provisional Patent Application entitled “Method and System for Providing Secure, Instantaneous, Directory-Integrated, Multiparty, Communications Services” filed on Nov. 2, 2000 and having Serial No. 60/245,136.

### FIELD OF THE INVENTION

The present invention relates to a system and method for providing secure, spontaneous multiparty voice and data communications.

### BACKGROUND

In today's distributed team-oriented enterprise workspace, the ability to conduct multiparty conferencing anytime, anywhere, on demand and continuously has become critical to increasing productivity and effectiveness of group work. Group work is often highly interactive and spontaneous with geographically distributed team members having a need to collaborate in real time in order to perform their tasks. In addition to regularly scheduled meetings, impromptu communications are commonplace.

Critical to increasing the productivity of group work is the ability of group members to communicate with each other in an efficient manner. Today, the widespread availability of networked multimedia computers, handheld communicators, and cellular phones greatly helps co-workers keep in touch with each other, regardless of their geographical locations. Some advanced PSTN/ISDN phones allow multiple calls to be bridged on demand. However, this bridging capability is unavailable on most telephones and does not support voice over internet protocol (IP). Most existing systems that allow multiparty conferencing for both PSTN and voice over IP users require conferences to be scheduled in advance and enforce resource constraints. For example, many systems limit the maximum number of participants and the duration of a conference. Hence, these systems cannot support the spontaneity of enterprise group communications in an efficient manner.

One effective approach to address the issue of scheduling impromptu conferences among dispersed members is to enable group members to see the presence and availability state of each group member in real time. In this way, group members know when to initiate new communications and when to invite other members to ongoing communications.

Existing commercial instant messaging applications enable a group of users to communicate based on the presence and availability state of each user. However, most of these systems are designed for public use and lack certain features that are critical for enterprise use. For example, in most commercial instant messaging applications, the support for audio communications is limited to one-to-one and lacks security.

The widespread availability of network computer resources, and the routing of communications over the internet, also increases the risk that malicious entities may attempt to disrupt the system or a particular system feature. Therefore, critical to the effective usage of efficient communication within a work group is the guarantee of security such as access control, communication confidentiality, entity authentication, and communication integrity.

It is therefore an object of the present invention to provide a Secure Enterprise Communications system that allows users to create multiparty conferences securely and instantaneously without a prior scheduling.

It is a further object of our invention to allow users to participate in both text and audio multiparty conferences simultaneously. Further, our invention allows users to participate in multiple, multiparty conferences simultaneously and facilitates switching between conferences.

It is a further object of our invention to separate conference control from conference participation and to separate communications media from the communications medium.

### SUMMARY

In the Secure Enterprise Communications (SEC) system of our invention, an audio conference may have a combination of IP-IP, IP-PSTN, and PSTN-PSTN connections. The type of connection that is established depends on the preferences of the conference participants. For example, User A, who creates the conference, prefers to use the desktop phone, whereas User B, who is invited to the conference, likes to use her multimedia PC. Hence, SEC establishes an IP connection to User B's PC and a PSTN connection to User A's telephone and bridges the two connections in the conference. When User C, who uses a cell phone, joins the conference, the SEC system establishes a PSTN connection to User C's cell phone and adds User C to the conference. In our invention, the participants do not dictate the communications medium of the other participants. Rather, the participants only specify the type of media through which they wish to communicate (e.g., voice) and the specific communications medium to be used is determined by the preference of each individual participant.

In our invention, users may create text only or voice only conferences each of which may be changed spontaneously to both voice and text and then back. The conference, whether for two or more people is created in a novel way using the Session Initiation Protocol (SIP) protocol as specified by the Internet Engineering Task Force. Also, at conference creation, the security for the conference is set up using the SIP protocol in a novel way.

Once a conference has been created there is provision for any participant to add one or more participants to the conference at any time. There is also provision for any participant to leave the conference, including the user who created the conference, without affecting other conference participants. As participants join and leave the conference the Presence and Availability List (PAL) associated with the conference changes dynamically to reflect these changes and all conference participants see these changes. Similarly, the state of conference participants can change during the conference and these changes are reflected in the conference PAL. For example, a user can stay connected to the conference but indicate that they are temporarily busy if they are not actively listening because they may be actively participating in a second conference. Note: Users may participate in multiple conferences, in different ways, at the same time.

There is a PAL associated with each user to indicate the presence and availability of their friends, associates, and other entities, and a different PAL associated with each conference. Users manage their PAL through a user interface which allows them to add and delete entries in the PAL. PALs for all users are held separately in the SEC data base. A user's PAL is available on the UI if the device is capable of displaying the PAL. PAL availability information is updated as it changes through a subscribe/notify paradigm. One embodiment of our invention allows for a PAL to reference other users or other objects such as persistent conferences, or a lamp in a bedroom. The availability attributes differ by type of object.

The SEC network and service security can logically be viewed as consisting of four phases. In the first phase, the set-up phase, servers execute the SEC key generation protocol to generate a secret key. The secret key is then used for encryption and authentication of messages exchanged between servers.

In the second phase, the registration phase, a SEC client and the Kerberos authentication server execute the Kerberos protocol. Using Kerberos, the client is authenticated to the server. When execution is completed, the client and server share a private session key that is used for encryption of messages exchanged between the client and SEC network server.

In the third phase, the join/leave phase, when the conference controller receives a join request from a SEC client, the conference controller creates a conference session key if one is not already present, encrypts the conference session key with the private session key associated with the client and communicates the conference session key to the client.

The fourth phase, the send/receive phase, is executed when a SEC client wishes to communicate a message to another client participating in a common conference. The client who creates the message uses the conference session key to encrypt the authentication, time stamp and message data. Using the conference session key, the message receiver decrypts the authentication and time stamp tags and if successful decrypts the message to recover the original data.

### BRIEF DESCRIPTION OF THE DRAWINGS

FIG. 1 depicts an illustrative secure enterprise communications system of the present invention.

FIG. 2 depicts a representation of a block diagram of a client in accordance with our invention.

FIGS. 3a, b and c depict three different implementations of a client in accordance with our invention.

FIG. 4 depicts a method of operation in accordance with our invention in which servers generate and share keys

FIG. 5a illustrates a block diagram of a security process within a client of our invention.

FIG. 5b depicts a method of operation in accordance with our invention in which a user registers with the SEC network

FIG. 6 depicts a method of operation in accordance with our invention in which a conference is created

FIG. 7 depicts a method of operation in accordance with our invention in which a conference is joined

FIG. 8 depicts a method of operation in accordance with our invention in which text messages are exchanged

FIG. 9 depicts one method of operation in accordance with our invention for SEC encryption

FIG. 10 depicts one method of operation in accordance with our invention for Managing Presence and Availability Lists (PALs)

### DETAILED DESCRIPTION OF PREFERRED EMBODIMENTS

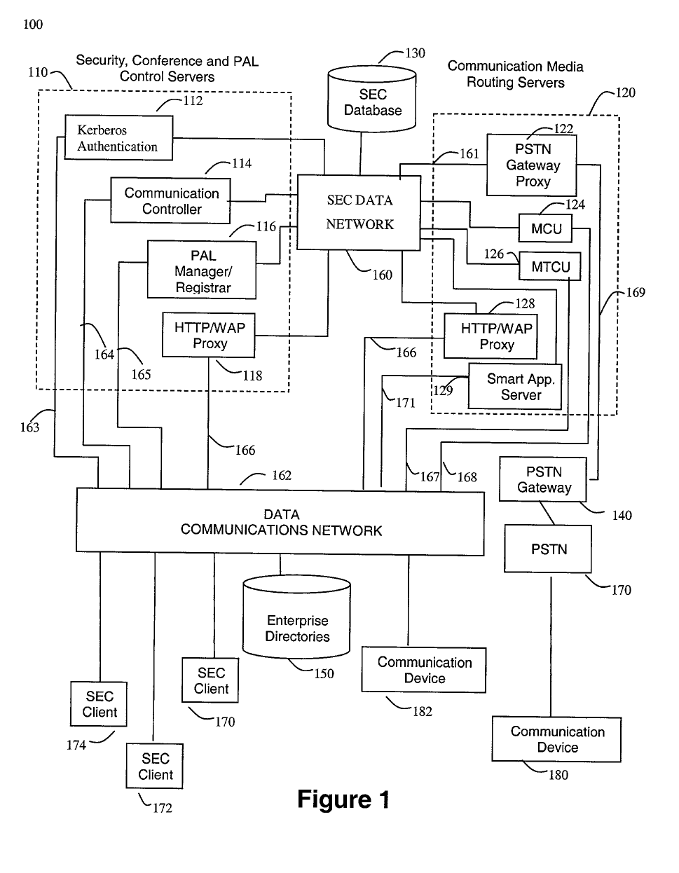

FIG. 1 illustrates a Secure Enterprise Communications (SEC) system 100 according to a one embodiment of our invention. The illustrative SEC system 100 comprises a distributed two-tier client-server system: the control server's tier 110 and the communications servers tier 120. The illustrative SEC system 100 also includes a SEC database 130, a SEC data network 160, a PSTN gateway 140, a PSTN 170, a communications network 162, an enterprise directory 150, at least two SEC clients 170,172, and at least two communication devices 180, 182. The control server's tier 110, forms the main interface through which SEC clients 170 obtain services. The communications server's tier 120 is primarily responsible for transporting media streams between communicating clients.

SEC Clients

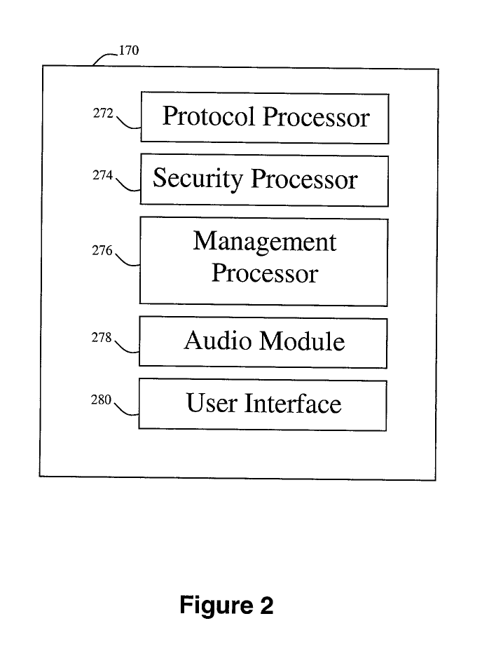

FIG. 2 is a block diagram of a SEC client 170 in accordance with the invention. A SEC client may be incorporated into another device such as a personal digital assistant (PDA), a third generation wireless access protocol (WAP/3G) device, or a personal computer. The SEC client may also be a stand-alone device. The SEC client may also be integrated into a voice interface device such as an IVR system to allow users to access SEC services via PSTN phones. The SEC client includes a protocol processor 272, a security processor 274, a SEC management processor 276, a user interface (UI) that may be graphical 280, and may include an audio module 278.

The protocol processor 272 provides connectivity between external sources such as control servers and the processing capabilities of the security processor 274, the SEC management processor 276, and the audio module 278, which renders the audio stream if one is present. The functionality invoked by the protocol processor 272 depends on the protocol being used between the external source and the SEC client 170. In addition, the security processor 274 is responsible for processing and managing security between the SEC client 170 and the other elements of the SEC network. The security processor 274 is responsible for executing key generation and user authentication processes with the Kerberos authentication server 112. In addition, the security processor 274 is responsible for media stream encryption, decryption, and message and date authentication. In an illustrative embodiment, the security processor 274 executes the Kerberos security protocol for user authentication and key generation.

The SEC management processor 276 is responsible for processing and management related to SEC services such as client registration, conference initiation and management, and presence and availability list (PAL) management.

The audio module 278 performs mixing and playback of audio media for the client. It also serves to capture audio input.

The UI 280 provides an interface between a user and the SEC client processor. The UI 280 allows a user to enter information required for SEC services. In an illustrative embodiment of our invention, the UI supports the capability for a user to control a single conference or to control multiple conferences simultaneously. It also allows users to create and view PAL information.

SEC clients 170 are connected to the control server's tier 110 through the communications network 162. The communications network 162 may be a private or public data network such as the Internet or a wireless communications network.

In our invention, control capabilities are separated from communications capabilities. The SEC clients 170 perform tasks associated with control such as conference, message, and PAL signaling with the control server's tier 110. Communications devices 180 perform tasks associated with communications such as generating and rendering media such as audio and text. This separation allows the encapsulation of the design and implementation details specific to a particular client platform. In addition, the separation significantly increases the flexibility with which users access SEC services.

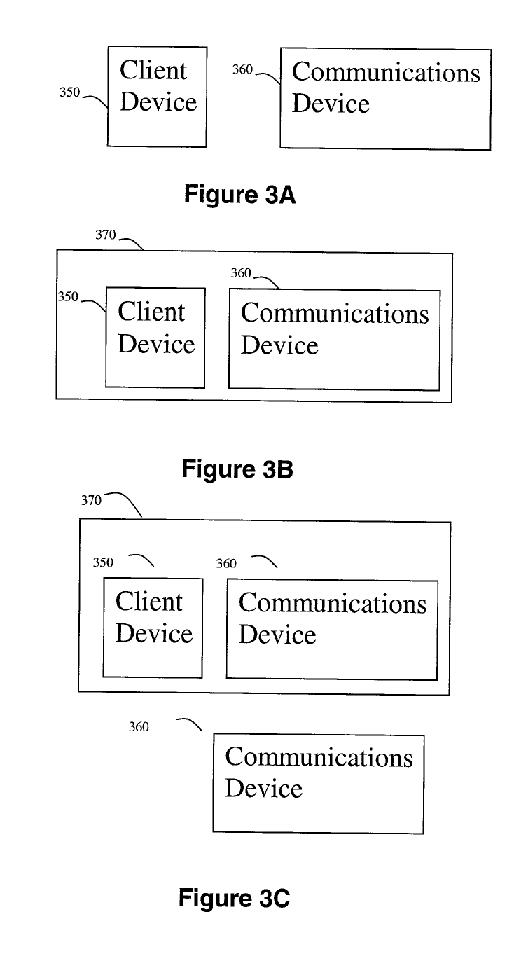

SEC clients and communications devices can be implemented in various ways. In an illustrative example of FIG. 3a, a user's SEC client device 350 and communications device 360 are implemented in separate devices. In an alternative embodiment illustrated in FIG. 3b, a user's client device 350 and communications device 360 are integrated on a single device 370. In an alternative embodiment illustrated in FIG. 3c, a user may have multiple communications devices either separate, or at least one integrated into the same device with the SEC client.

For example, the office user who prefers the desktop phone for audio communications or whose desktop PC is not multimedia capable, can still fully utilize the SEC services by running the SEC client program on a desktop PC and participating in audio conferences using a desktop phone. Likewise, a mobile user who has a networked personal digital assistant (PDA) and a cell phone can run the SEC client program on the PDA for SEC signaling and use the PDA as a communications device for text communications and the cell phone as a communications device for audio communications.

Control Tier

The control server's tier 110 is comprised of one or more Kerberos authentication servers 112, one or more communication controllers 114, one or more PAL managers 116, and one or more HTTP/WAP proxy control servers 118. In an illustrative embodiment, each server is implemented on a separate hardware component. Alternatively, all the servers or any combination of servers may be implemented on a single hardware component. The number of each type of server and the architectural arrangement of servers is dependent upon the constraints of the particular network. The control servers communicate with other control servers and with the communications servers through the SEC data network 160 via data links 162. SEC data network may be a private or public data network.

The Kerberos authentication server 112 authenticates users during the log-in phase. The Kerberos authentication server 112 communicates with SEC clients 170 via data link 163. The communication controller 114 is responsible for setting up conferences between users, maintaining user information such as current contact addresses and communications preferences, and interfacing with the integrated enterprise directory. The communications controller 114 communicates with SEC clients 170 and the enterprise directory 150, through data communications network 162.

The PAL manager 116 maintains PALs and manages subscription information related to users and conferences. This subscription information includes subscription to presence and availability data of other users, conference participation data, or may even include the presence and availability of other objects whose information may be accessed over the network (e.g. whether a specific lamp in an office or home is on or off). The PAL manager 116 also manages registrations of system users and objects referenced by the users. The PAL manager 116 communicates with SEC clients via data link 165.

The communications controller 114 and the PAL manager 116 communicate with SEC clients 170 using data communications protocols. The protocol used for control signaling between clients and control servers and between control servers and other control servers or communications servers has five primary properties. First, the protocol supports a globally unique user identifier. Second, the protocol supports user mobility through user registration or an alternative method. Third, the protocol allows communication to the same client to be automatically redirected to different locations depending on where the client is currently registered. Fourth, the protocol allows users to subscribe to events and proactively notifies clients of the updates on the subscribed events. Fifth, the protocol allows protocol messages to contain application data as their message body.

In one embodiment of our invention, the Session Initiation Protocol (SIP) is used as the control signaling between SEC clients and the control server and the SEC clients and the routing servers. SIP is an Internet Engineering Task Force (IETF) standard for an application layer designed to support multimedia multicast and point-to-point connections in an IP environment.

The HTTP/WAP proxy control server 118 allows users to access SEC services using web, or WAP phone, browsers. The proxy control server 118 provides a remote UI to a SEC client running on the proxy server. The HTTP/WAP proxy control server 118 receives user commands as HTML or WML documents and transforms them into SEC operations before sending them to SEC servers. Likewise, the HTTP/WAP proxy control server 118 receives the results of these operations from SEC servers and transforms them into HTML or WML documents before sending them to the client. Thus, the HTTP/WAP proxy control server 118 enables users to use the Web browsers of their choice, or WAP-enabled handheld devices, to access the SEC services. At the same time, the HTTP/WAP proxy control server 118 hides the particularities of the Web browsers and WAP-enabled handheld devices from the SEC servers and allows them to process the commands coming from devices using this gateway in the same way as commands coming from SEC client applications. Similarly proxy translators could be implemented to convert future communication standards to commands accepted by the SEC servers.

The SEC database 130 contains the PAL data for SEC subscribers and other client specific data. The centralized storage of PALs allows SEC users to download their PAL to their SEC client and removes the need for the users to separately keep the PAL on their own. A PAL entry sometimes referred to as a “buddy” is defined as an object that maintains a set of <ATTRIBUTE, VALUE> pairs. The SEC network sends update notifications when the VALUE of a selected ATTRIBUTE changes. The<ATTRIBUTE, VALUE> set of a PAL entry comprises the entry's presence data, availability data, and other associated data. Different entry types may have different<ATTRIBUTE, VALUE>s ets. Examples of PAL entry types include USER, CONFERENCE, LAMP, etc. A SEC network provider may also define additional PAL entry types. SEC maintains a USER object for each registered PAL entry. The PAL data of each registered SEC user is maintained in the SEC database 130 even when the user is not registered in the network (i.e., the user is “offline”).

The Communications Controller 114 maintains a CONFERENCE object for each ongoing conference. For a conference, the PAL entry is used as the conference participant list and conveys the participant status of each conference participant. Participant status values may include “AVAILABLE,” or “BUSY.” The user may customize the values. The PAL entry may also include additional information related to the conference. The SEC database also maintains an object for other PAL types such as a specific lamp.

Communication Server Tier

The communications servers tier 120 is comprised of one or more PSTN gateway proxy servers 122, one or more multipoint control unit (MCU) servers 124, one or more multipoint text control unit (MTCU) servers 126 (aka. Chat servers), one or more HTTP/WAP proxy communications servers 128 and one or more Smart Application Servers (SAS) 130. The number of each type of server required is dependent upon the architecture design criteria of a particular network. In an illustrative embodiment, each server may be implemented on a separate hardware component. Alternatively, all the servers or any combination of servers in both tiers may be implemented on a single hardware component. The control servers communicate with other control servers and with the communications servers through the SEC data network 160 via data links 161.

The MCU server 124 is responsible for routing the audio packets to the appropriate destination for clients participating in a conference. It does this by looking in the SEC database for the conference ID found in the audio packet to determine the participants in the conference and then sending the packet to those participants. The MCU server 124 manages participant membership of each ongoing audio conference in the system. The MCU server 124 communicates with communications devices 180 via data link 168. Data link 168 supports various communications protocols such as RTP, H.323, or SIP. RTP is a standard for streaming media over the internet. H.323 is a standard that specifies the protocols that provide multimedia communication services over packet networks.

The MTCU server 126 routes text messages to appropriate destinations, sends the same text messages to multiple locations in multi party conferences, and manages the participant membership of each ongoing text conference in the system. In an illustrative embodiment of our invention, SIP is used to transport text payloads to a text communications device and RTP is used to transport audio payloads to computer-based communications devices.

The PSTN gateway proxy server 122 enables the participation of PSTN phones in SEC audio conferences. The PSTN gateway proxy server 122 mixes multiple audio streams into a single stream and sends the new stream to the PSTN gateway 140 connected to the destination communications device 180. The PSTN gateway proxy server 122 also routes audio streams from a telephone user to the appropriate MCU server 124 which in turn routes them to their destinations. The PSTN gateway proxy sever 122 communicates with the PSTN gateway 140 via data link 169. Data link 169 supports audio communications protocols such as real-time transport protocol (RTP) and H.323.

The HTTP/WAP proxy communications server 128 allows users to communicate with other SEC users using HTTP or WAP browsers. The HTTP/WAP proxy communications server 128 receives media in HTML or WML format and transforms the media into the appropriate format before sending the media stream to SEC servers. Likewise, the HTTP/WAP proxy communications server 128 receives media streams from SEC servers and transforms the streams into HTMP/WML before sending them to the client.

The SEC servers and SEC clients may be integrated with one or more enterprise directories 150. The enterprise directories 150 store and allow access to the contact information of enterprise employees including their names, user identifiers, email addresses, and phone numbers. The enterprise directories allow users to quickly add participants to their PAL and to quickly contact other users not on their PAL. Users may search for other users using any piece of contact information such as first name, last name, phone number, location, etc. The directory may return one or multiple entries depending on the search criteria (aka. one person or all persons in an organization, or all persistent conferences).

Server to Server Communication Security

Prior to providing services to SEC network subscribers, security for server-to-server communications must be initiated. In an illustrative method of operation, during SEC network initiation, the control servers and communications servers execute a key generation protocol. The key generation protocol creates a joint key that is used for authenticating servers and for encrypting later communications between the servers. In an illustrative embodiment of our invention, the servers execute a SEC key generation protocol based on the Diffie-Hellman key generation protocol.

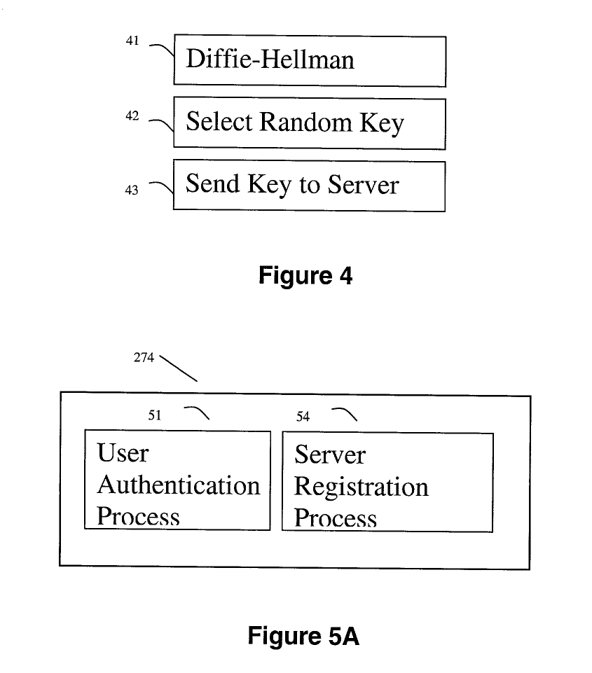

FIG. 4 sets forth an illustrative method of operation in which servers generate and share keys. Using the SEC key generation protocol, multiple servers are able to compute a joint key that looks random to any adversary observing the communication among them. In step 41, one server does a Diffie-Hellman exchange with server 2. As a result of the Diffie-Hellman exchange, key, K₂¹, is shared between server 1 and server 2. Server 1 then randomly selects a key K (step 42). In step 43, server 1 uses key K₂¹ to send key K to server 2 in an encrypted, authenticated and time-stamped form. This process can be extended to operate in an environment of more than 2 servers with the initial server conducting an Diffie-Helman exchange with any number of other servers and generating a key Kⁱ¹ for “i” number of servers.

In an alternative embodiment, the servers do not generate a joint key and server-to-server messages are sent unencrypted.

User Registration

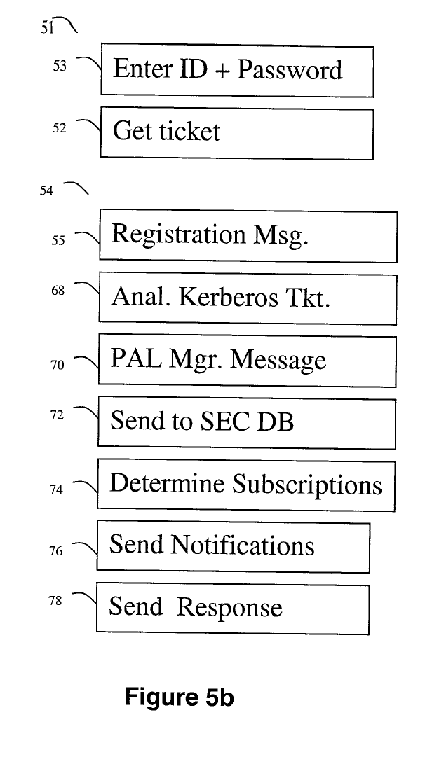

FIG. 5a depicts a block diagram of the security processor 274 in which a user registers with the SEC network 100. This user registration process consists of a user authentication process 51 and a SEC service registration process 54. As shown in FIG. 5b, the user authentication process 51 is initiated when a user logs into the SEC network 100 by entering his identifier and password via the UI 280 (FIG. 2) of the SEC client 170 of FIG. 1 (step 53).

After receiving the identifier and password from the user, the security processor 274 of the SEC client executes the Kerberos protocol and during protocol execution, exchanges messages with the Kerberos authentication server 112 to obtain a Kerberos ticket (step 52). Kerberos is a private-key authentication system that requires the existence of a trusted network entity that acts as an authentication server for clients and servers requesting authentication. After the SEC client 170 receives the Kerberos ticket, the SEC service registration process 54 is initiated.

The SEC service registration process begins at step 55 when the SEC management processor 276 communicates a registration message to the PAL manager 116. The registration message includes the Kerberos ticket, the user's preference data, and the current contact information for the user. Upon receiving this data, the PAL manager 116 authenticates the SEC client 170 by analyzing the Kerberos ticket (step 68). The PAL manager also communicates with the security processor to generate a SEC client session key for client to server security and communicates the SEC client session key securely to the SEC client. The SEC client session key is used by the security processor 274, to encrypt and decrypt messages between the SEC client 170, and the PAL manager 116, and between the SEC client 170, and the communications controller 114.

If authentication is not successful, the PAL manager 116 sends a message to the SEC client 170 indicating that registration has failed. If authentication is successful, the PAL manager sends a message to the communication control 144 including the registration, preference and contact information associated with the user (step 70). The contact information for the user includes a host IP address and port number if User A is to be contacted via an IP device or a phone number if User A is to be contacted via a traditional phone connection. In addition, the PAL manager 116 sends a message containing this information to the SEC database 130 (step 72). The SEC database 130 then stores this information in a record associated with the user.

The PAL manager 116, in step 74, determines whether the user has subscriptions to other users or objects in the system. If the user has subscriptions, the PAL manager 116 sends a notification message for each subscription of the user to the SEC client 170 associated with user (step 76). The notification message of step 76 contains the up-to-date presence and availability data of a subscription of the user. The SEC client 170 associated with the user receives the notification message and locally constructs the user's PAL. Note that step 76 may occur at any time after the registration message and will likely occur after the response message is sent in step 78.

In step 78, the PAL manager 116 sends a response message to the SEC client 170 indicating that registration was successful. The response message includes a SEC client session key, the user's current PAL data, and the contact address of the communications controller 114 to be used by the client during this session. The SEC client 170 stores the information contained in the response message in a local storage medium.

In an illustrative embodiment of our invention, after registration processing is complete, messages exchanged between a SEC client 170 and control servers are encrypted using the client session key. In an alternative embodiment, messages between a SEC client 170 and control servers are sent unencrypted.

Conference Creation

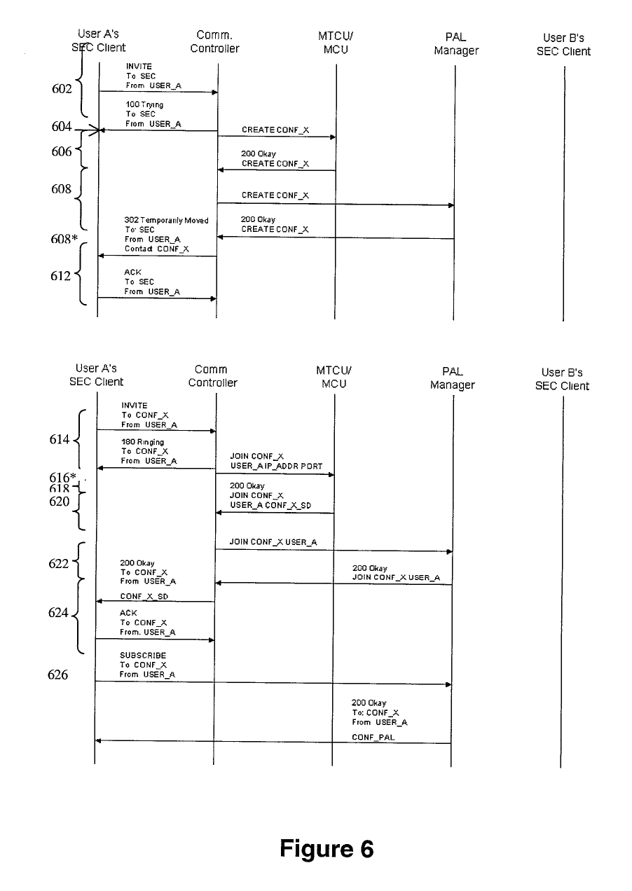

FIG. 6 sets forth a method of operation in which a conference is created as a result of a SEC client request using SIP. In this embodiment, a user, User A, is attempting to create a conference with another user, User B. User A has a SEC client device 170 for initiating the conference and a communications device 180 for participating in the conference by transmitting media streams. User A's SEC client device 170, and communications device 180, may be integrated into the same device or may be separate devices.

The method as depicted in FIG. 6 begins when the SEC client 170 associated with User A communicates an invitation message such as a SIP INVITE message to the communications controller 114 (step 602). The invitation message in step 602 is shown to be addressed to a predefined user for the SEC network, including PSTN users. In an alternative embodiment, an invitation message that initiates a conference is addressed to the default super user for the SEC network (e.g., the communications controller). The invitation message in step 602 also identifies the type of media for this conference (e.g., audio or text) requested by User A.

When the invitation is received, the communications controller 114 creates a new conference by generating and assigning a unique conference identifier to the conference (step 604). This conference identifier may be in the form of a SIP URI (e.g., sip:hyongsop@research.telcordia.com) or another globally unique identifier. In an illustrative embodiment of our invention, the communications controller 114 also generates a conference session key for encrypting messages exchanged between conference members during the conference. The conference session key is encrypted with the client session key associated with User A when it is conveyed to User A.

In step 606, the communications controller 114 selects a communications server to be used in the conference and notifies the server selected that a new conference has been created. The message in step 606 includes the conference identifier and the identifier of the predefined user. The communications controller 114 selects the communications server based on the media type of the conference identified in the invitation message. For example, a single MTCU server 126 is selected for a text conference and a MCU server 124 is selected for a audio conference. Where there are multiple MCUs or MTCUs, one with spare capacity is selected to control the conference.

PAL Processing

The communications controller 114 also notifies the PAL manager 116 of the creation of the new conference (step 608). Based on this notification, the PAL manager 116 registers the conference in the SEC database 130 so that participants of the conference can subscribe to the presence data of the conference (step 610). Upon receiving acknowledgment messages from the PAL manager 116 and the selected communications server, the communications controller 114 sends a redirection message to the SEC client 170 associated with User A (step 612). The redirection message of step 612 includes the conference ID of the new conference and the encrypted conference session key. In an illustrative embodiment, the message of step 612 is a standard SIP response for redirecting calls (i.e., the “302 Temporarily Moved” response). The SEC client 170 associated with User A acknowledges receipt of this response by sending an acknowledgement message to the communications controller 114.

After sending an acknowledgment message, the SEC client 170 associated with User A communicates a second invitation message to communications controller 114 (step 614). The invitation message in step 614 is addressed to the conference identifier assigned to the new conference. The invitation message may also include session description information such as the IP address and port number of the client and the types of media streams supported. Upon receiving the second invitation message, the communications controller 114 retrieves preference information associated with User A from the SEC database in order to determine the appropriate communication method for this media type required by User A (step 616).

In step 618, the communications controller 114 sends a join message to the selected communications server indicating that User A is joining the new conference. If User A is currently a VoIP user, the message of step 618 also includes the IP address and port number of User A's host computer to which the communications server should transmit the audio stream. If User A is a phone user, the message of step 618 includes the phone number where User A can currently be reached.

In response to the join message, the selected communications server confirms that User A has joined the new conference and sends an acknowledgment message to the communications controller 114 (step 620). The acknowledgment message includes the IP address and port number of the selected communications server to which the communications device 180 associated with User A should transmit messages. The communication controller 114 sends a second join message to the PAL manager 116 indicating that User A has joined the new conference (step 622).

In step 624, the communication controller 114 sends a response message to the SEC client 170 associated with User A. The response of step 624 includes the IP address and port number for the communications server assigned to this conference. In an illustrative embodiment, the response message is a SIP OK message.

After receiving the response, the SEC client 170 associated with User A communicates a subscription message to the PAL manager 116 to subscribe to the presence and availability data of the new conference (step 626). The subscription message of step 626 is addressed to the conference identifier of the new conference. Upon receipt of the subscription message, the PAL manager 116 verifies that User A is a participant of the new conference. In addition, an indicator that the SEC client 170 should be notified whenever the presence and availability data of the new conference changes is stored in the SEC database 130 in the record associated with the conference. In step 628, the PAL manager 116 communicates a response message to SEC client 170. The response of step 628 contains the current participant list of the conference (i.e., User A). The participant list data is transported in the message body.

When the SEC client 170 that is associated with User A receives the response message a new conference has been initiated for User A. At this point, if User A is a phone user in a audio conference, her phone would be ringing (e.g., the MCU for the new conference is calling User A's communication device 180 via a PSTN gateway 140). Alternatively, if User A is a computer user, a connection would have been established between User A's computer (SEC client 170) and the MCU 124.

Conference Join

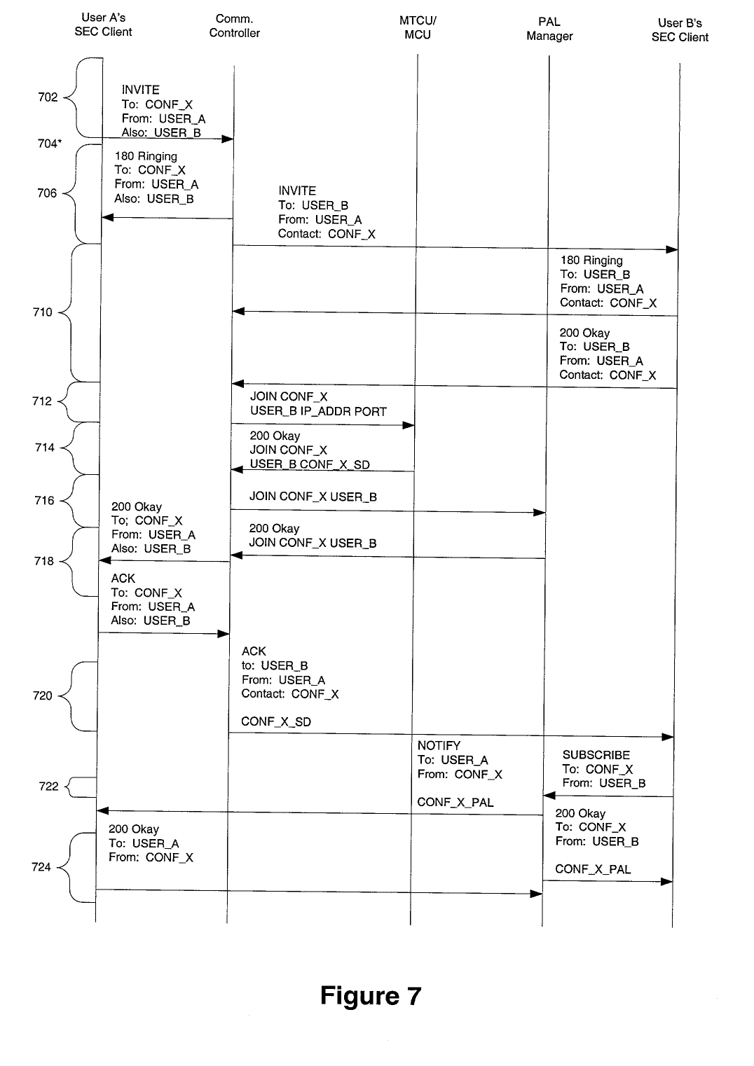

FIG. 7 depicts a method and message flow in which a user is invited to join an existing conference. We shall refer to this conference as Conference X for ease of description. The method as depicted in FIG. 7 begins when the SEC client 170 associated with User A sends an invitation message such as a SIP INVITE message to the communications controller 114 (step 702). The invitation message of step 702 is addressed to the conference identifier of Conference X and includes the user identifier for User A. The invitation message may include communications details such as the contact address and equipment supported by User A. The invitation message also includes a proposed header addressed to the user identifier of User B. The user identifier of User B may be in the form of a SIP URI. Note that if User B is on User A's PAL, this invitation message is sent only when the PAL entry associated with User B in User A's SEC client 170 shows that User B is available to communicate.

Upon receiving the invitation message, the communication controller 114 determines whether User B is currently registered in the SEC network 100 by querying the SEC database 130 (step 704). If User B is not currently registered, the communications controller 114 sends a message to User A indicating that User B is not available at this time. If User B is registered, and User B is available, the communications controller 114 communicates a second invitation message to the SEC client 172 associated with User B (step 706). The invitation message of step 706 is addressed to the user identifier for User B and includes the user identifier for User A and the conference ID. The user identifier for User A is included as a URI in the SIP From header field and the conference ID is included as a URI in the SIP Contact header field.

Upon receipt of the second invitation message, the SEC client 172 associated with User B first checks the availability status of User B. If User B is busy or otherwise unavailable, e.g., User B has set the presence and availability setting of the SEC client 172 associated with User B to BUSY, the SEC client 172 associated with User B sends a response message to communication controller 114 indicating that User B is busy and cannot join the conference. In an illustrative embodiment, the response message is a SIP 486 Busy Here response. Otherwise, the SEC client 174 associated with User B alerts User B of an incoming call (step 708). If User B accepts the invitation from User A, the SEC client 172 associated with User B sends a response message to communications controller 114 indicating that User B has agreed to join the conference (step 710). In an illustrative embodiment, the response message is a SIP 200 OK response. If User B declines the invitation from User A, the SEC client 172 associated with User B sends a response message to communications controller 114 indicating that User B has declined to join the conference. In an illustrative embodiment, the response message is a SIP 603 Decline response.

In step 712, upon receiving a favorable response message, the communications controller 114 sends a join message to the communications server assigned to conference X indicating that User B is joining the conference. The communications controller 114 also includes in the join message of step 712 the contact information from User B's preference settings stored in the SEC database 130. For example, User B may prefer to be contacted at the IP address and port number of his computing device. Alternatively, User B may prefer to be contacted at his current phone number.

In response to the join message, the selected communications server confirms that User B has joined the new conference and communicates an acknowledgment message to the communications controller 114 (step 714). The acknowledgment message includes an IP address and port number to which the communications device 182 associated with User B should transmit messages. The communication controller 114 sends a second join message to the PAL manager 116 indicating that User B has joined the new conference (step 716). In step 718, the communications controller 114 sends a response message to the SEC client 170 associated with User A indicating that User B has joined the conference.

After receiving the join message from the communications controller 114, the PAL manager 116 communicates a message to the SEC client 170 associated with User A notifying User A of the current subscribers to the presence and availability data of Conference X (step 719). Step 719 can occur at any point after the PAL manager 116 receives the join message of step 716. In an illustrative embodiment, the message of step 719 is a SIP Notify message.

Meanwhile, in step 720, the communications controller 114 sends a message to the SEC client 172 associated with User B acknowledging that User B has joined the conference. The acknowledgement message of step 720 includes the IP address and port number of the communications server assigned for Conference X to which User B's communication device 182 should transmit messages. In addition, the acknowledgment message may also include the conference session key encrypted using User B's client session key.

After receiving the acknowledgment message, the SEC client 172 associated with User B communicates a subscription message to the PAL manager 116 to subscribe to the presence and availability data of conference X (step 722). Upon receipt of the subscription message, the PAL manager 116 verifies that User B is a participant of the new conference. In step 724, the PAL manager 116 communicates a response message to SEC client 170. The response of step 724 contains the current participant list of Conference X (i.e., User A and User B) in the body of the message.

In an alternate embodiment of our invention, a user, User A, selects directory entities from the Enterprise Directories 150 for SEC users with whom User A wishes to communicate. The Enterprise Directories 150 communicate the contact information including the user identifier for each selected directory entity. The SEC client associated with User A then uses the contact information to invite these entities to join an existing conference using the methods described in association with FIG. 7.

Text Message Exchange Using SIP

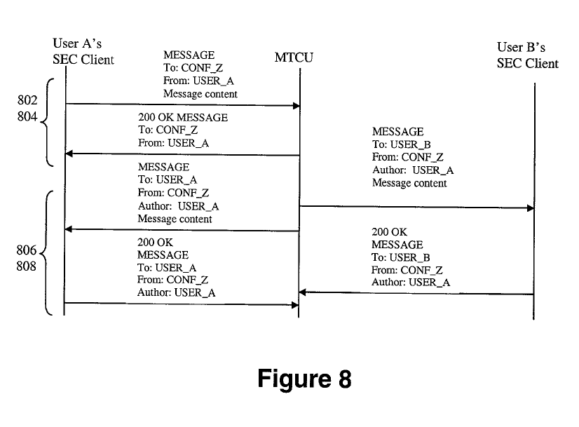

FIG. 8 depicts a method of operation in which text messages are exchanged between users in an existing text conference. We shall refer to this conference as Conference Z for ease of description. Because Conference Z is a text conference, the communications server assigned to Conference Z is the MTCU 126. The method as depicted in FIG. 8 begins when the SEC client 174 associated with one of the users, for simplicity we will refer to this user as User C, generates a message addressed to the conference identifier of conference Z (step 802). The message of step 802 includes User C's text message as its body. In step 804, the SEC client associated with User C transmits the message to the MTCU 126.

Upon receiving this message, the MTCU 126 creates a new message addressed to the user identifiers associated with each conference participant, in this case User A and User C (step 806). Each new message includes the user identifier of the conference participant and the<author, user identifier of author> pair followed by the message content of the original text message from User C. In step 808, the MTCU 126 communicates each new message to its corresponding destination.

The SEC client of the destination user retrieves the<author, user identifier of author>pair and the message content from the message (step 810) and communicates a response to the MTCU 126. User C's receipt of the original text message from the MTCU is indication that it has also been sent to the others in the conference. Responding to a received message in a text conference works exactly like sending a new message. All text messages are encrypted using the conference key.

Audio Messages

In an embodiment of our invention in which voice messages are exchanged, the MCU server 124 limits the number of audio streams that can simultaneously be active in a conference in order to effectively utilize available network bandwidth. In the SEC network 100, an active audio stream is defined as a series of audio packets originated from a single speaker's communication device 180, that are played out or rendered by another communication device 182. Because human ears can typically distinguish between a limited number of simultaneous active audio streams, when more than a predefined number of participants simultaneously speak in a conference, the MCU server 124 selects a predefined number from all the active streams and routes those selected streams to their corresponding destinations.

In a given conference, both the predefined value and the active stream selection algorithm used by the MCU server 124 depend on the administrative policy for the conference. One example of such an active stream selection algorithm is to route a predefined number of “loudest” audio streams. The administrative policy of a conference may be set by the conference creator or moderator and may also be updated while the conference is ongoing to best suit available network bandwidth or the need of the specific conference.

In an alternative embodiment, users participating in a conference communicate by exchanging encrypted, authenticated, and time-stamped messages. The security processor 274 of the SEC client of the user sending data, uses the conference session key to encrypt, authenticate and timestamp the data. The conference session key is provided to each participant when the participant joins the conference as described above. Note, this is end-to-end encryption of the payload and the messages need not be decrypted in the middle of the network for mixing. The message headers are unencrypted.

Conference Spawning

Because of the centralized control inherent in our invention it is easy to create new conferences from existing conferences. This is necessary when conference participants desire to communicate using an additional media, for example when communicating using text becomes too slow and voice communication is desired.

In an embodiment of our invention any user in a text conference can decide to create a voice conference between the same participants. For example, User A who is participating in Conference 1, uses the SEC Client 170 associated with User A, to request the Communication Controller 114 to create a voice conference that contains all the participants in Conference 1. Communication Controller 114 then creates a new voice conference, Conference 2. Then using the PAL information in the SEC Database 130 regarding Conference 1 it invites all participants in Conference 1 that have SEC Clients that have the ability to participate in a voice conference to join Conference 2. A new conference security key is created and used for Conference 2. A new PAL is created for Conference 2 since not all the participants in Conference 1 may be able to participate in Conference 2. Any of the participants in Conferences 1 and 2 may leave at will including the user who initiated either of the conferences. Leaving conference 1 will not automatically cause the user to leave Conference 2. They must also leave Conference 2. Any participant in Conference 1 may still invite another user to join Conference 1 and that user will also be asked to Join Conference 2. The methods and procedures used to create Conference 2 are those described earlier for creating and joining a conference.

Directory Services

Not all the users that a user wishes to communicate with appear in the user's personal PAL. In one embodiment of our invention, the Enterprise Directories 150, can be used to initiate the conference. The user uses the User Interface of the SEC Client 170 to access one or more Enterprise Directories 150 to find the other user they want to communicate with. Then using the User Interface of the SEC Client 170 they request the Communication Controller 114 to establish the conference as described earlier. If a user wishes to communicate with a group of users identified by one of the attributes in the Enterprise Directories 150 they may use the User Interface of the Sec Client 170 to specify that attribute (aka. all users in organization 1256) and the Communication Controller 114 will create a conference consisting of those users.

In one embodiment of this invention the Enterprise Directories 150 are also used to determine the availability, of users shown in the directory, to communicate. Using the User Interface of the SEC Client 170, User A requests the Communication Controller 114 to provide an entry for a specified user, User B. Along with the normal attributes of the user (Address, Phone Number, etc.) is the shown the same availability information that would be shown in the PAL if that person were a part of User A's PAL. If User A specified an alternative attribute other than a users name, which resulted in multiple entries being shown (aka. an organization number) the availability information would be shown for all entries shown.

Conference Metadata

There may be cases where an authorized user may need to monitor ongoing conferences without having to actually participate in them. For example, the supervisor of a help desk may wish to see which representative is helping which customers in an unobtrusive manner. In addition, a manager may need to be in multiple conference calls at the same time and wish to make a decision as to which conference call to listen in, based on the PAL of each call, while still monitoring the attendance of the other calls.

In these cases the user can use the User Interface of the SEC Client 170 to request that the Communication Controller 114 provide the PAL of a specific conference. The Communication Controller 114 requests the information from the PAL Manager 116 and the information is returned to the SEC Client 170. The user becomes aware of the Conference identification by some off line mechanism or by using the User Interface of the SEC Client 170 to access the Enterprise Directories 150 which in one embodiment of this invention contains a directory that contains the Conference Identification for selected conferences.

Multiple Voice Conferences

The present invention allows a user to participate in multiple, multiparty, multimedia conferences at the same time. For example, User A, using SEC client 170 can participate in Conference 1 with User B, using SEC client 172 and User C using SEC client 174 and others. At the same time User A, using SEC client 170 can participate in Conference 2 with users D, E, and F and others. At the same time User A, using SEC client 170 can participate in Conference 3 with Users G, and H, and perhaps more Conferences. It is assumed that most of the time the conferences have sparse communication, perhaps with the communication coming in bursts. All input voice streams are mixed at the SEC Client 170 so the user can hear any participant in any conference who speaks. The User Interface for SEC Client 170 allows the user to see a PAL for each conference and to see graphically which conference currently has speakers and even who the speaker is. The SEC Client 170 knows this because a conference ID and a speaker ID is associated with each incoming packet and each incoming packet holds content from one user.

In an embodiment of this invention the microphone of the SEC Client 170 and the other users SEC Clients are turned off. Because of this there is no data being sent over the Data Communications Network 162. When User A decides to use the SEC Client 170 to talk to User B who is using SEC Client 172 and User C who is using SEC Client 174, User A clicks on a button associated with Conference 1 on SEC Client 170 to turn on the microphone and then talks. Participants in conferences other than Conference 1 do not hear him because the MCU 124, using the headers of the voice data packets (which identifies the appropriate conference), routes the voice only to the users in Conference 1.

In an embodiment of this invention User A may indicate using the User Interface of SEC Client 170 that the microphone should be left on for a specified conference so User A may participate in the conference talking naturally without further indication that they want to talk. The user may also indicate using the User Interface of SEC Client 170 that they want to listen to only the participants in a particular conference. This request is sent to Communication Controller 114 that signals the MCU 124 that packets from Conference 2, and Conference 3 and other conferences that User A may be participating in, temporarily not be transmitted. In an alternative embodiment of this invention the SEC Client 170 merely suppresses playing the data packets associated with Conference 2, Conference 3, and other conferences User A may be participating in. When User A focuses on one conference in this manner, the PAL lists for Conference 2, Conference 3, and other conferences User A may be participating in, show that User A is still in the conference but is busy and not participating fully at this time.

After User A, User B, User C and any other participants finish their immediate business, User A using the User Interface for SEC Client 170 can restore SEC to the initial state where several conferences are being monitored.

Monitoring several sparse conferences may become intrusive if the other users voices are heard. Thus User A using the User Interface of SEC Client 170 can cause one voice utterance to be transformed to a single sound “ear con” which indicates someone is talking. In one embodiment of this invention one continuous utterance from another participant in the conference is transformed into a click. Thus, each time a participant speaks a click is heard at SEC Client 170. A series of clicks means that a conversation is taking place. Different sounds can be assigned to specific people (such as User A's manager). Alternatively a special sound may be assigned to all speakers in a conference with a different sound being assigned to each conference. Basically, unique sounds can be assigned to speakers or conferences at desired.

Alternately User A using the User Interface of the SEC Client 170 can elect to turn off sound altogether and indicate activity visually, such as with a blinking icon on the interface.

Alternately User A using the User Interface of the SEC Client 170 can elect to not hear or see anything unless he is specifically addressed by another participant at which time an alert will sound.

Note the same users may be in multiple conferences. For example, User A, User B, and User C may be in a conference using SEC Clients 170, 172 and 174, respectfully. At the same time User A and User B may be in a separate conference without User C using SEC Clients 170 and 172.

Note we have given the example of voice conferences but users may participate similarly in text conferences, or mixtures of voice and text conferences to the extent that the users SEC Client and Communication Devices allow.

Persistent Conferences

So far we have described transient conferences. Using the methods and procedures associated with this invention, users can also create persistent conferences. Persistent conferences differ from transient conferences in that they do not disappear when all users have disconnected from the conference.

In an embodiment of this invention User A uses the User Interface associated with SEC Client 170 to signal the Communication Controller 114 to create a persistent conference PC1. User A can then invite User B and User C and others to conference PC1 in the same manner as they would invite User B and User C to a normal conference. However, now when Users A, B and C leave conference PC1 the Communication Controller 114 does not delete it and the MCU 124 and the MTCU 126 still remember it. Then at a later date, User A, B or C, or all of them together, can rejoin the conference. In addition, Communication Controller 114 keeps information in the SEC Database 130 indicating that User A created conference PC1 and is considered the owner. Persistent conference owners have special capabilities that apply to persistent conferences, such as being able to delete the conference, or change the security keys of the conference. Owners can also block selected users from joining the conference or simply specify a list of users who are allowed to join the conference.

Since persistent conferences are persistent, users can attach text or voice files to the conference using the User Interface of the SEC client 170, and can also obtain those files for playing or viewing using the same User Interface.

When a persistent conference is spawned, the new conference is automatically made persistent. Furthermore, when a participant re-joins the parent conference, SEC allows the participant to automatically re-join any child conferences of that parent conference.

Smart Application Sharing

Our invention also allows users to share applications within the auspices of a conference. First User A using the User Interface of SEC Client 170 requests that an application sharing conference be created by signaling Communication Controller 114. Communication Controller 114 creates the conference and makes the users specified by User A the participants. This is accomplished in the manner specified earlier for voice conferences with one difference. The difference is that instead of contacting the MCU 124 to control the voice messages, the Communications Controller 114 contacts a Smart Application Server 129 to run the application and communicate with the conference participants. The Smart Application Server 129 then obtains the data necessary for the application by obtaining it from User A's computer using a negotiated well known protocol such as FTP. Examples of such data include, but are not limited to, Microsoft Word documents, Microsoft PowerPoint viewgraphs, and Microsoft Excel spreadsheets. Once the data is obtained, the Smart Application Server 129 starts the application that is needed to edit and/or view the data and connects to the SEC client of each conference participant using an application sharing protocol such as, but not limited to, T.120 (http://itu.int/publibase/itu-t/ltutAllbvSeries.asp.serie=t) With T.120, the application runs only on the Smart Application Server 129, and all conference participants see the application output on the User Interface of their SEC clients. In addition, input control is first given to the user who starts the application sharing conference, in this case User A using SEC Client 170, and subsequently is passed from participant to participant as a participant asks for, and is granted control by, the current owner.

In an alternate embodiment, smart application sharing is accomplished by replicating the shared data and having the shared application run on the computer of each conference participant and the Smart Application Server 129. In this architecture, input to the application is captured and sent to the Smart Application Server 129 by the SEC client of the conference participant who has input control. In turn, the Smart Application Server 129 applies the received input to its copy of the data and the application and then sends the input to the other conference participants who apply the received input to their copies of the data and the application. Capturing and applying input to the shared data and the shared application may be performed using, but not limited to, the Microsoft COM Automation Interface. As before, input control is passed from participant to participant.

In both architectures, the Smart Application Server 129 is keeping the latest state of the shared data and the shared application. This way, a newcomer to the conference can receive the current state of the shared data and the shared application upon joining the conference and can begin participating in the conference with minimal delay and overhead. In addition, the Smart Application Server 129 can store the state of the shared data and the shared application in its database so that the conference may suspend and resume at a later time. Furthermore, the Smart Application Server 129 can support user/terminal mobility; that is, a participant can leave the conference, move to a different computer, and later join the conference again.

Once the conference is over, the shared data may be sent back to the original owner using FTP, or some similar file transfer protocol, from the Smart Application Server 129 to the SEC client of the owner. Alternately it can be sent to some or all of the conference participants, and/or stored at the Smart Application Server 129. The exact actions taken may depend on the conference policy, which the original owner of the shared data or any one with appropriate authorization may set before and/or during the conference.

Encryption

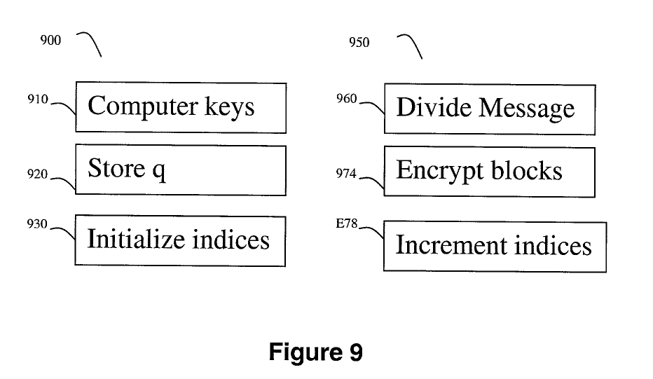

FIG. 9 sets forth a method of SEC encryption in accordance with FIG. 1. The encryption process of our invention is modular and can be used with any block cipher algorithm such as DES or AES. The SEC encryption process consists of an offline process 900 and an online process 950. Both processes are executed in the security process 274 of the SEC client 170. The offline process 900 generally applies to a period of time when no communication activity is occurring in a conference (e.g., no one is speaking in a audio conference) but can be executed while there is speaking activity when necessary. The offline process 900 is used to compute encryption/decryption subkeys from the conference session key. Each subkey is used to encrypt/decrypt the basic unit of media payload. The online process 950 applies to a period of time when some communication activity is occurring in the conference (e.g., communication media payloads are being generated and consumed).

In the method of FIG. 9 of our invention, we assume that each client, upon joining a group is provided a conference session key K and a number t of starting counters, ctr₁, . . . , ctrₜ (for t=log n, where n is an upper bound on the number of conference members). The numbers, ctr₁, . . . , ctrₜ, determine which subkeys the client uses to encrypt its message payloads. Furthermore, the client sends ctr₁, . . . , ctrₜ in encrypted form with its encrypted payloads so that the recipients can know which sub keys to use in order to decrypt the encrypted payloads.

In the offline process 900, for q=1, . . . , n, the q-th client computes in the security processor 274, key_{i,index}=DES_{K}(ctr₁+index), for i=1, . . . , t, and index=1, 2, . . . , MAX, where MAX indicates the maximum number of unused keys to have at any time (step E10). The security processor 274 of the q-th client next writes q in binary and stores q (step E20). The binary expansion of q gives t bits, q₁, . . . , q₁. The security processor 274 initializes t indices, ind₁=1, for i=1, . . . , t, where ind₁ is associated with sequence key_{i,index} for index=1, . . . , MAX (step 930). The offline process is typically initiated when a SEC client 170 receives notification that other users have joined the conference. Whether or not additional offline processing is required when new clients join a conference is dependent upon the indices q of these new users.

In the online process 950, to encrypt a message, the security processor 274 divides the message into 64-bit blocks (i.e., let the message=M₁, . . . , Mₕ where |M_{C}|=64 (step 960). The security processor 274 next stores the current indices before encrypting the message blocks (e.g., start_ind₁=ind₁=1, for all i=1, . . . , t such that qᵢ=1. To encrypt each 64-bit message block M_{c}, the security processor 274 of the q-th client first computes P_{c} as the XOR of all key_{i,ind1} such that q₁=1 (step 970). The security processor 274 next computes C_{c}=M_{c} XOR P_{c} (step 974). In step 978, the security processor 274 increments by 1 all indices ind₁ such that q₁=1. The encryption of the message will be (q; start_indᵢ for all I such that q₁=1) and (C₁, . . . , Cₕ).

Note that for any client, decrypting can be done by analyzing at the most t keys that have been computed in the off-line phase and performing (at most) t XOR's (for instance, M_{c}=key_{i,ind1}, XOR, . . . XOR key_{i,indt}XOR C_{c}. In addition, the security processor 274, of the decrypting clients, update indices indᵢ exactly as the encrypting client does.

The number of clients, q, and the number of starting counters, t, depend on how many clients have joined the conference. We ensure that this number is unique without the need for distributed communication as follows: q is represented as the concatenation of a server number which is decided in the setup phase and a client number among clients associated with the conference server. The client number is determined by the server and assigned to the client when the client joins the conference.

In an alternative embodiment, the SEC encryption/decryption process is as follows. First of all assume that each client, upon joining a group, is provided a conference session key K and a number n of starting numbers, where n is the number of conference members. In the offline process, for q=1, . . . ,n, the q-th client computes in the security processor 274 Key_{q,index}=DES_K(ctr_{q+index}), for index=1, 2, . . . , MAX. The security processor 274 initializes n indices ind_{q=1}, for q=1, . . . , n. In the online process, to encrypt a message, the security processor 274 of the q-th client divides the message into 64-bit blocks M₁, . . . , Mₕ, where |M_{c}|=64, encrypts each block M_{c} by computing C_{c}=M_{c} XOR Key_{q,ind}_{_{—}}_{q}, and increments ind_{q} by 1. Note that for any client, decrypting block C_{c} can be done by computing M_{c}=C_{c} xor Key_{q,ind}_{_{—}}_{q}, where q is the index of the client that has sent the ciphertext.

Date Authentication and Time Stamping

The data authentication and time-stamping process of our invention is modular and can be used with any cryptographic algorithm conjectured to be a collision-free function, such as MD5 or SHA. The time-stamping process consists of attaching the current time T to the message M to be authenticated. The data authentication process consists of security processor 274 computing function HMAC(K,M)=MD5(M∥T∥MD5(M∥T∥K)), where K is the conference session key.

For a secure audio conference, the gateway proxy 122 decrypts and encrypts the audio stream flowing through the gateway proxy 122 from PSTN phones. In a secure audio conference, the communications controller 114 sends to the gateway proxy 122, via the MCU 124, the conference session key of the audio conference encrypted with a secret key shared by the communications controller 114 and the gateway proxy 122. Audio streams between the gateway proxy 122 and the PSTN gateway 140 are encrypted and audio streams between the PSTN gateway 140 and the phone are not encrypted. In an illustrative embodiment, the audio streams between the gateway proxy 122 and the PSTN gateway 140 are encrypted using H.235.

Managing PALs

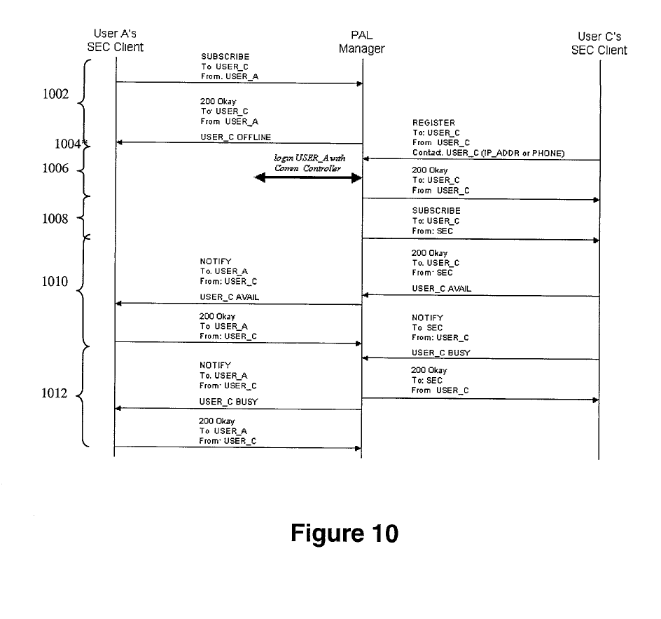

FIG. 10 depicts a method of operation in accordance with FIG. 1 for managing presence and availability lists (PALs) commonly known as “buddy lists” in the instant messaging community. In the method of FIG. 10, User A is adding User C to her PAL so that User A can automatically be notified of User C's status in the SEC network 100 (e.g., offline, available, busy, etc.). The method as depicted in FIG. 10 begins when the SEC client 170 associated with User A sends a subscription message to the PAL manager 116 (step 1002). The subscription message of step 1002 is addressed to the user identifier for User C.

Upon receiving the subscription message, the PAL manager 116 verifies that User A has the appropriate permission to have this subscription (step 1004). In an illustrative embodiment of our invention, the PAL manager 116 uses a rule-based mechanism to allow or deny the subscription even if User C is offline. For example, the PAL manager 116 can use an enterprise organization and group chart stored in the SEC database 130 as a basis for making this decision.

If User A is permitted to have this subscription, the PAL manager 116 obtains the current presence and availability data of User C from the SEC database 130 and communicates this information to the SEC client 170 associated with User A. In an illustrative embodiment, the response message is a SIP 200 OK response.

In the situation where User C is offline, when User C registers in the SEC network 100, the PAL manager determines whether User C has a subscriber (step 1006). Because User A has subscribed to User C's PAL data, the PAL manager sends a second subscription message addressed to the user identifier for User C (step 1008). The second subscription message contains an identifier for the PAL manager 116. The second subscription message also serves as notification to User C that other users or objects are subscribing to his PAL data.

Upon receipt of the second subscription message, the SEC client 174 associated with User C sends a response message to the PAL manager 116 (step 1010). The response message of step 1010 contains the current presence and availability data of User C. In an illustrative embodiment, the response message is a SIP 200 OK response.

The SEC client 174 associated with User C does not receive a subscription message for each subscriber to User C's PAL data. The SEC client 174 only receives a single subscription message with the identifier of the PAL manager 116. In order to identify the identifiers of the subscribers to User C's PAL data, the SEC client 174 associated with User C sends a subscription message to the PAL manager 116. In an illustrative embodiment, the subscription message is a SIP SUBSCRIBE message with the URI of the PAL manager 116 in the SIP To header and 0 in the SIP Expires header. Upon receiving the subscription message, the PAL manager 116 sends a response containing the user identifiers of all subscribers to User C's PAL data.

Upon receiving the response message of step 1010, the PAL manager 116 sends a message to the SEC client 170 associated with User A notifying User A of the current PAL data of User C as included in the response message of step 1010 (step 1012).

Although the invention has been shown and described with respect to exemplary embodiments thereof, it should be understood by those skilled in the art that various changes, omissions and additions may be therein and thereto, without departing from the spirit and scope of the invention.

We claim:

1. A communications system for spontaneous enterprise conferencing comprising:
at least one conference server located within a network;
at least one routing server located within a network;
at least one client software application associated with a user where said client software application may be separate from a user's communications device used for participation in a conference;
a data communications network for enabling said associated user client software application to communicate with said conference server to initiate and receive conference participation requests; and
wherein said conference server maintains presence and availability data for each said other users for each conference established and wherein said routing server establishes the communications media connection to said user's communication device for participation in said established conference.

2. The system of claim 1 wherein said conference server is comprised of a means for authenticating a users access to a conference.

3. The system of claim 1 wherein said conference server is comprised of a means managing and updating said presence and availability lists stored in said database.

4. The system of claim 1 further comprising:
a database containing a lists of other users for which a first user may want to know of the their presence and availability in said system and wherein said conference system retrieves from said database said list of users for said first user to establish said conference.

5. The system of claim 1 wherein said routing server is further comprised of:
a public switched telephone network gateway;
a means for multipoint audio conferencing; and
a means for multipoint text conferencing and
a means for application sharing.

6. The system of claim 5 further comprising:
a mixing means located within each of said clients for mixing the communications from any one of said conferences sent by either said means for multipoint audio conferencing or said means for multipoint text conferencing.

7. A spontaneous enterprise communications server comprising:
a database containing lists of other users one user may want know of their presence and availability;
a means for authenticating a users access to a conference
a means managing and updating said presence and availability lists stored in said database;
a public switched telephone network gateway;
a means for multipoint audio conferencing; and
a means for multipoint text conferencing.

8. A method for establishing a conference between participants in a system having a client server architecture, wherein said method comprises:
using the Session Initiation Protocol defined by the Internet Engineering Task Force for conference establishment wherein said client sends a SUSCRIBE message to said server to access the presence data of said conference; and
said server responds to said SUBSCRIBE message by sending a NOTIFY message to said client whenever the presence data of said conference changes.

9. A system for multiparty instantaneous communications comprising:
a centralized process for controlling communications access; and
a plurality of processes, each located with every end user device, for mixing multiple audio or textual communications connections wherein communications control is effected using the Session Initiation Protocol defined by the Internet Engineering Task Force.

10. The system of claim 9 wherein said centralized process for controlling communications access further comprising a means for establishing an object for each instantaneous communications sessions.

11. A system for establishing a conference between participants in a system having a client server architecture, wherein said system comprises:
a protocol means for conference establishment between said client and said server and wherein said protocol is characterized in having:
a globally unique user identifier;
enables users to subscribe to one or more conferences;
enables said server to redirect communications to a conference; and
enables said server to proactively notify one or more clients of any changes to any of said subscribed conferences.

12. The system of claim 11 wherein said protocol means is a Session Initiation Protocol means.

13. A method for inviting a user to join a conference in a system having a client server architecture, wherein said method comprises:
using the Session Initiation Protocol defined by the Internet Engineering Task Force for conference establishment;
sending an INVITE message from a first user to a communications control process;
responding to said INVITE message by forwarding said INVITE message from said first user from said communications control process to a second user; and
said second user accepts the invitation to join the conference by sending an OKAY message to said communications control process; and
said second user sends to said communications control process an address of a device said second user intends to use for participating in said conference.

14. The system of claim 2 further comprising:
a means for service registration.

15. The system of claim 1 further comprising:
an enterprise directory.

16. A method for secure instantaneous communications comprising the steps of:
generating a joint key for authenticating servers in a system;
authenticating a client to a server by generation of a second key;
encrypting messages between servers using said joint key; and
encrypting messages between a server and said client using said second key.

17. The method of claim 16 further comprising the steps of:
creating a conference session key for each conference; and
encrypting said conference session key with said second key for communication said conference session key to said client.

18. The method of claim 17 further comprising the steps, executed by a client, of:
encrypting authentication, time stamp and message data to be sent to a second user on a conference; and
sending said encrypted authentication, time stamp, and message data to said second user wherein a client of said second user decrypts said authentication and time stamp data using said conference key and if said authentication and time stamp data is valid said second user decrypts said message data using said conference key.

19. The method of claim 18 further comprising the step of:
sending message data in encrypted, authenticated and time stamped form to multiple conference participants at the same time.

20. A method for creating a conference in a system having a client server architecture, wherein said method comprises:
sending message from a first user client to a communications control process to initiate a conference;
creating a conference object in said communication control process located in a control server for maintaining the presence and availability data of users to participated in said conference;
requesting a conference communications facility from a multiparty control process located in a routing server;
returning a conference identifier to said first user client; and
establishing a communications path from a user's communications device to said multiparty control process.

21. The method of claim 20 further comprising the steps of:
requesting that a second user join said conference;
checking the presence and availability to see if said second user is able to join said conference;
forwarding said conference request to said second users client;
said second user client sending a join message back to said conference controller specifying a device address and media to be used for the conference; and
connecting said second users device to said multiparty control process.

22. The system of claim 9 further comprising means for establishing multiple conferences using multiple devices simultaneously from a single user.
